(19) United States
(12) Patent Application Publication
(10) Pub. No.: US 2025/0003026 A1
(43) Pub. Date: Jan. 2, 2025

(54) REDUCING AND NON-BLAST FURNACE SMELTING METHOD OF ALKALINE VANADIUM-TITANIUM PELLETS AND HOT-PRESSED CARBON-CONTAINING VANADIUM-TITANIUM PELLETS

(71) Applicant: PANGANG GROUP PANZHIHUA IRON & STEEL RESEARCH INSTITUTE CO., LTD., Panzhihua (CN)

(72) Inventors: Wenbo TANG, Panzhihua (CN); Mao CHEN, Panzhihua (CN); Fengxiang ZHU, Panzhihua (CN); Ning WU, Panzhihua (CN)

(21) Appl. No.: 18/689,783

(22) PCT Filed: Jun. 27, 2023
(86) PCT No.: PCT/CN2023/102674

§ 371 Date: Mar. 6, 2024

(30) Foreign Application Priority Data
Nov. 15, 2022 (CN) 202211429564.8

(51) Int. Cl. C22B 5/12; C22B 1/24; C22B 5/18

(52) U.S. Cl. CPC C22B 5/12; C22B 1/2406; C22B 5/18

(57) ABSTRACT

A reducing and non-blast furnace smelting method of alkaline vanadium-titanium pellets and hot-pressed carbon-containing vanadium-titanium pellets. By upgrading the vanadium-titanium concentrates, improving quality of the reducing gas, increasing the proportion of the reduction section of the shaft furnace, removing the cooling section to achieve hot charging, and improving the electric furnace, the method accelerates the reduction rate of the vanadium-titanium pellets reduced by the gas-based shaft furnace, improves the final reduction degree of the vanadium-titanium pellets, achieves the rapid non-blast furnace smelting of the vanadium-titanium pellets. Addition of the hot-pressed carbon-containing pellets can alleviate the problems caused by reduction swelling of pellets, overcome the problem that the alkaline vanadium titanium pellets do not meet the requirement of a reduction swelling rate of less than 10% of fed pellet ore for gas-based shaft furnace since its high reduction swelling rate, and broaden the variety of fed pellets for the shaft furnace.

### TECHNICAL FIELD

The present invention belongs to the field of ferrous metallurgy, in particular to non-blast furnace iron-making technology, specifically a reducing and non-blast furnace smelting method of alkaline vanadium-titanium pellets and hot-pressed carbon-containing vanadium-titanium pellets.

### BACKGROUND

At present, there is no industrial application example of smelting with vanadium-titanium ore using non-blast furnace short-process smelting technology. However, China has a huge reserve of vanadium-titanium magnetite, it is urgent to develop a non-blast furnace short-process technology suitable for smelting with vanadium-titanium ore under a context of double-carbon (peak carbon dioxide emissions and carbon neutrality) policy. Compared with ordinary pellets, vanadium-titanium pellets have difficulty in reduction and long reduction time. By using non-blast furnace technology suitable for ordinary pellets smelting, there will be a series of problems such as low metallization rate of metallized pellets, high carbon content in an electric furnace, and high process energy consumption.

### SUMMARY OF THE INVENTION

In order to overcome the above defects of the prior art, the present invention provides a non-blast furnace smelting method suitable for vanadium-titanium ore. By upgrading vanadium-titanium concentrate, improving the quality of the reducing gas, increasing the proportion of the reduction section of the shaft furnace, removing the cooling section to achieve hot charging, improving the electric furnace and the like, the present invention achieves the continuous smelting of non-blast furnace short-process of the vanadium-titanium pellets with high metallization rate, and the carbon emission per ton of iron can be reduced at the same time.

In order to achieve the purpose, the present invention provides a reducing and non-blast furnace smelting method of alkaline vanadium-titanium pellets and hot-pressed carbon-containing vanadium-titanium pellets, including following steps:

\textcircled{1} Upgrade a vanadium-titanium iron concentrate, and prepare alkaline pellets having an alkalinity of 0.6-0.7 from the upgraded vanadium-titanium iron concentrate and fine-grained limestone.

The vanadium-titanium iron concentrate before upgrading features a TFe content of 53-55%, a TiO₂ content of 10-12%, and a passing rate of 200-meshe sieve of greater than 85%. After grinding until the proportion of the vanadium-titanium iron concentrate with a particle size of −0.038 mm accounts for greater than or equal to 90%, the grinded concentrate is roughly selected with a 0.2 mT magnetic field to obtain a roughing iron ore powder and a tailings, then the roughing iron ore powder is finely selected with a 0.15 mT magnetic field, the tailings after roughly selecting is subject to scavenging with a 0.2 mT magnetic field, and the ore powders after finely selecting and scavenging are the upgraded vanadium-titanium iron concentrate. The upgraded vanadium-titanium iron concentrate features a TFe content of 60-64%, a TiO₂ content of 8-11%, a passing rate of 800-mesh sieve of greater than 90%. A proportion of the fine-grained limestone with a particle size ratio of −0.1 mm is greater than or equal to 95%.

The alkaline pellets are prepared by using a belt roaster with a preheating temperature of 900-950° C., a preheating time of 13-17 minutes, a roasting temperature of 1250-1280° C., and a roasting time of 15-20 minutes.

The alkaline pellets prepared in step \textcircled{1} features a TFe content of greater than or equal to 60%, a reduction swelling rate of less than or equal to 12%, and an average crushing strength of pellet of greater than or equal to 3000 N.

\textcircled{2} Prepare hot-pressed carbon-containing pellets with the upgraded vanadium-titanium iron concentrate and a pulverized coal, wherein a proportion of the pulverized coal is 17-28%, and a proportion of the upgraded vanadium-titanium iron concentrate is 72-83%. A uniform mixture of the upgraded vanadium-titanium iron concentrate and the pulverized coal is hot-pressed and molded at 250-350° C., and then nitrogen is introduced at 900-950° C. to remove volatile components in the pulverized coal.

In step \textcircled{2}, the pulverized coal for preparing the hot-pressed carbon-containing pellets is one-third coking coal or fat coal. The pulverized coal features a volatile component content of 20-32%, a fixed carbon content of 60-70%, and an ash content of 6-12%. The hot-pressed carbon-containing pellets prepared in step \textcircled{2} features a TFe content of 45-56%, a C content of 10-22%, and an average crushing strength of greater than or equal to 5500 N. Shrinkage occurs during the reduction process with a shrinkage rate of 8-15%, which can supplement heat inside the shaft furnace, compensating some of the heat absorbed during H₂ reduction process.

\textcircled{3} By means of a pressure swing adsorption process, prepare H₂ with coke oven gas as a raw material and prepare CO with converter gas as a raw material, where a purity of each the prepared H₂ and CO is greater than or equal to 99%. Mix the prepared H₂ and CO to obtain a reducing gas, featuring H₂/CO of greater than or equal to 8, H₂+CO of greater than or equal to 90%, and a H₂ volume content of greater than 80% and less than 100%.

\textcircled{4} By mixing a remained gas after capturing CO₂ from blast furnace gas with the prepared CO, prepare a fuel gas for heating the reducing gas.

Collect blast furnace gas and capture CO₂ from the blast furnace gas, enabling a CO₂ content in the remained gas after capturing CO₂ from blast furnace gas to be less than or equal to 3% and a CO content to be greater than or equal to 30%. Mix the CO₂-removed blast furnace gas and the prepared CO to prepare the fuel gas, of which an amount of the CO₂-removed blast furnace gas is 10-30%. The fuel gas features a CO volume content of greater than or equal to 80% and a N2 volume content of less than or equal to 20%.

\textcircled{5} Feed the reducing gas and the fuel gas into a shaft furnace through a double-layer conveying pipeline, where the fuel gas and air are fed through an inner layer, the reducing gas is fed through an outer layer, and the inner layer and the outer layer are isolated with each other by a high thermal conductivity refractory. In addition, a volume ratio of the fuel gas to the air is greater than or equal to 2.3:1 to ensure excessive fuel gas, enabling a O₂ content in the tail gas after combustion to be less than 3%. A temperature of the reducing gas is 1050-1080° C., a pressure of the reducing gas is 0.7-0.8 MPa, and a flow of the reducing gas is 15-20 L/min.

\textcircled{6} Use a burden structure, containing the alkaline pellets and the hot-pressed carbon-containing pellets with a mass ratio of 1-5:1, as a shaft furnace burden. In addition, the conveying pipeline of the reducing gas is arranged at a bottom of a reducing section and at half of the reducing section of the shaft furnace. The reducing gas pipeline arranged at half of the reduction section is configured for heat replenishment to the middle-upper part of the reduction section of the shaft furnace, accounting for 30-50% of a total length of the conveying pipeline of the reducing gas, which is adjusted according to the H₂ content in the reducing gas. The cooling section of the shaft furnace is removed, a length ratio of the reducing section is increased to account for 60-80% of a height of the shaft furnace, and a hot charging process from the shaft furnace to the electric furnace is adopted. An unloading section is provided with a metallized pellet storage bin having valves at both upper and lower ends, the storage bin is provided with an inlet and an outlet. The tail gas (with an O₂ content of less than or equal to 3%) after combustion of the fuel gas is introduced into the unloading section. The tail gas contains a lot of CO and a very low O₂ content, having a reductive overall atmosphere, which can be used for carburizing and improving the metallization rate, while providing heat for the metallized pellets, keeping the temperature of the pellets in the storage bin higher than or equal to 800° C., so as to ensure that the metallization ratio of the metallized pellets entering the electric furnace can be greater than or equal to 92%.

Further, the mass ratio of the alkaline pellets to the hot-pressed carbon-containing pellets in the burden structure of the shaft furnace is 1-5:1.

\textcircled{7} The electric furnace has a structure with four feed ports, two iron notches, and two slag notches, which can achieve a continuous loading technology.

The electric furnace is provided with four feed ports, of which opposite two are pellet feed inlets, and the other two are respectively a solvent inlet and a fuel inlet. Each the pellet feed inlet is connected to the shaft furnace storage bin through a chute, so as to realize the hot charging of the metallized pellets, and a hot charging temperature is greater than or equal to 700° C. The electric furnace is provided with upper and lower iron notches and upper and lower slag notches. The upper and lower iron notches are configured to discharge iron. The upper slag notch is configured to control the liquidus and the pressure in the furnace, the lower slag notch is flush with the upper iron notch for slagging after discharging iron. A remaining iron process is adopted for smelting, and an addition amount of carbon is 8-13%.

Compared with the prior art, the present invention has the following beneficial effects: By taking the measures such as improving quality of the reducing gas and adding hot-pressed carbon-containing pellets, the present invention improves the reduction rate of vanadium titanium pellet ore in the gas-based shaft furnace, enhances the final reduction degree of vanadium titanium pellet ore, and realizes rapid non-blast smelting of vanadium titanium pellets. At the same time, the addition of hot-pressed carbon-containing pellets can alleviate problems caused by the reduction swelling of pellets, overcome the problem that the alkaline vanadium titanium pellets does not meet the requirement of a reduction swelling rate of less than 10% of fed pellet ore for gas-based shaft furnace since its high reduction swelling rate, and broaden the variety of fed pellets for the shaft furnace. Meanwhile, compared with a blast furnace, the present invention uses less carbonaceous reducing agents, which can reduce the energy consumption per ton of iron and carbon emissions.

### DETAILED DESCRIPTION OF PREFERRED EMBODIMENTS

The present invention is further described below with reference to specific embodiments, but is not limited in any way. To avoid repetition, the raw materials in the following embodiments are commercially available unless otherwise specified, and the methods used are conventional methods unless otherwise specified. Crushing strength of green pellets is determined by pressure method with a detection equipment of pellet crushing strength tester according to the standard GB/T 14201-2018 of “Iron Ore Pellets for Blast Furnace and Direct Reduction Feedstocks—Determination of The Crushing Strength”. Reduction swelling index is determined according to the standard GB/T 13240-2018 of “Iron Ore Pellets for Blast Furnace Feedstocks—Determination of the Free-Swelling Index”. Reduction rate index and the final reduction degree are determined and calculated according to standard GB/T 13241-2017 of “Iron Ores-Determination of Reducibility”.

A reducing and non-blast furnace smelting method of alkaline vanadium-titanium pellets and hot-pressed carbon-containing vanadium-titanium pellet as shown in Embodiments 1-3 includes the following steps, and the difference between each the embodiment and the comparative example is illustrated in the following implementation content.

\textcircled{1} Upgrade a vanadium-titanium iron concentrate, and prepare alkaline pellets having an alkalinity of 0.6-0.7 from the upgraded vanadium-titanium iron concentrate and fine-grained limestone.

The vanadium-titanium iron concentrate before upgrading features a TFe content of 55%, a TiO₂ content of 12%, and a passing rate of 200-meshe sieve of 88%. After grinding until the proportion of the vanadium-titanium iron concentrate with a particle size of −0.038 mm accounts for greater than or equal to 90%, the grinded concentrate is roughly selected with a 0.2 mT magnetic field to obtain a roughing iron ore powder and a tailings, then the roughing iron ore powder is finely selected with a 0.15 mT magnetic field, the tailings after roughly selecting is subject to scavenging with a 0.2 mT magnetic field, and the ore powders after finely selecting and scavenging are the upgraded vanadium-titanium iron concentrate. The upgraded vanadium-titanium iron concentrate features a TFe content of 64%, a TiO₂ content of 10%, a passing rate of 800-mesh sieve of 90%. A proportion of the fine-grained limestone with a particle size ratio of −0.1 mm is 96%.

The alkaline pellets are prepared by using a belt roaster with a preheating temperature of 900-950° C., a preheating time of 17 minutes, a roasting temperature of 1250-1280° C., and a roasting time of 20 minutes.

The alkaline pellets prepared in step \textcircled{1} features a TFe content of 64%, a reduction swelling rate of 9%, and an average crushing strength of pellet of 3100 N.

\textcircled{2} Prepare hot-pressed carbon-containing pellets with the upgraded vanadium-titanium iron concentrate and a pulverized coal, wherein a proportion of the pulverized coal is 24%, and a proportion of the upgraded vanadium-titanium iron concentrate is 76%. A uniform mixture of the upgraded vanadium-titanium iron concentrate and the pulverized coal is hot-pressed and molded at 250-350° C., and then nitrogen is introduced at 900-950° C. to remove volatile components in the pulverized coal.

In step \textcircled{2}, the pulverized coal for preparing the hot-pressed carbon-containing pellets is one-third coking coal. The pulverized coal features a volatile component content of 26%, a fixed carbon content of 65%, and an ash content of 8%. The hot-pressed carbon-containing pellets prepared in step \textcircled{2} features a TFe content of 50%, a C content of 16%, and an average crushing strength of greater than or equal to 5500 N. Shrinkage occurs during the reduction process with a shrinkage rate of 8-15%, which can supplement heat inside the shaft furnace, compensating some of the heat absorbed during H₂ reduction process.

\textcircled{3} By means of a pressure swing adsorption process, prepare H₂ with coke oven gas as a raw material and prepare CO with converter gas as a raw material, where a purity of each the prepared H₂ and CO is greater than or equal to 99%. Mix the prepared H₂ and CO to obtain a reducing gas, featuring H₂/CO of greater than or equal to 8, H₂+CO of greater than or equal to 90%.

\textcircled{4} By mixing a remained gas after capturing CO₂ from blast furnace gas with the prepared CO, prepare a fuel gas for heating the reducing gas.

Collect blast furnace gas and capture CO₂ from the blast furnace gas, enabling CO₂ content in the remained gas after capturing CO₂ from blast furnace gas to be 3% and a CO content to be greater than or equal to 30%. Mix the CO₂-removed blast furnace gas and the prepared CO to prepare the fuel gas, of which an amount of the CO₂-removed blast furnace gas is 10-30%. The fuel gas features a CO volume content of greater than or equal to 80% and a N2 volume content of less than or equal to 20%.

\textcircled{5} Feed the reducing gas and the fuel gas into a shaft furnace through a double-layer conveying pipeline, where the fuel gas and air are fed through an inner layer, the reducing gas is fed through an outer layer, and the inner layer and the outer layer are isolated with each other by a high thermal conductivity refractory. In addition, a volume ratio of the fuel gas to the air is greater than or equal to 2.3:1 to ensure excessive fuel gas, enabling a O₂ content in the tail gas after combustion to be less than 3%. A temperature of the reducing gas is 1050° C., a pressure of the reducing gas is 0.7-0.8 MPa.

\textcircled{6} A mass ratio of the alkaline pellets and the hot-pressed carbon-containing pellets of the burden structure is shown in Table 1. In addition, the conveying pipeline of the reducing gas is arranged at a bottom of a reducing section and at half of the reducing section of the shaft furnace. The reducing gas pipeline arranged at half of the reduction section is configured for heat replenishment to the middle-upper part of the reduction section of the shaft furnace, accounting for 30-50% of a total length of the conveying pipeline of the reducing gas, which is adjusted according to the H₂ content in the reducing gas. The cooling section of the shaft furnace is removed, a length ratio of the reducing section is increased to account for 60-80% of a height of the shaft furnace, and a hot charging process from the shaft furnace to the electric furnace is adopted. An unloading section is provided with a metallized pellet storage bin having valves at both upper and lower ends, the storage bin is provided with an inlet and an outlet. The tail gas (with a O₂ content of less than or equal to 3%) after combustion of the fuel gas is introduced into the unloading section. The tail gas contains a lot of CO and a very low O₂ content, having a reductive overall atmosphere, which can be used for carburizing and improving the metallization rate, while providing heat for the metallized pellets, keeping the temperature of the pellets in the storage bin higher than or equal to 800° C., so as to ensure that the metallization ratio of the metallized pellets entering the electric furnace can be greater than or equal to 92%.

\textcircled{7} The electric furnace has a structure with four feed ports, two iron notches, and two slag notches, which can achieve a continuous loading technology.

The electric furnace is provided with four feed ports, of which opposite two are pellet feed inlets, and the other two are respectively a solvent inlet and a fuel inlet. Each the pellet feed inlet is connected to the shaft furnace storage bin through a chute, so as to realize the hot charging of the metallized pellets, and a hot charging temperature is greater than or equal to 700° C. The electric furnace is provided with upper and lower iron notches and upper and lower slag notches. The upper and lower iron notches are configured to discharge iron. The upper slag notch is configured to control the liquidus and the pressure in the furnace, the lower slag notch is flush with the upper iron notch for slagging after discharging iron. A remaining iron process is adopted for smelting, and an addition amount of carbon is 8-13%.

The vanadium-bearing melted iron features a C content of 2.8%-3.8%.

The molten slag features a FeO content of 2%-5%, R₂ of 0.5-0.6, and a TiO₂ content of 30%-40%.

### Embodiment 1

In Embodiment 1, a reducing gas, with a H₂ content of 80%, a CO content of 10%, a N2 content of 7%, and a CO₂ content of 3%, was used. The reducing temperature was 1050° C., and the flow rate of the reducing gas was 15 L/min. The material structure was, as shown in Table 1, 83% of alkaline pellets and 17% of hot-pressed carbon-containing pellets. The reduction rate index and the final reduction degree determined by the laboratory are shown in Table 1.

### Embodiment 2

In Embodiment 2, a reducing gas, with a H₂ content of 80%, a CO content of 10%, a N2 content of 7%, and a CO₂ content of 3%, was used. The reducing temperature was 1050° C., and the flow rate of the reducing gas was 15 L/min. The material structure was, as shown in Table 1, 77.5% of alkaline pellets and 22.5% of hot-pressed carbon-containing pellets. The reduction rate index and the final reduction degree determined by the laboratory are shown in Table 1.

### Embodiment 3

In Embodiment 3, a reducing gas, with a H₂ content of 80%, a CO content of 10%, a N2 content of 7%, and a CO₂ content of 3%, was used. The reducing temperature was 1050° C., and the flow rate of the reducing gas was 15 L/min. The material structure was, as shown in Table 1, 72% of alkaline pellets and 28% of hot-pressed carbon-containing pellets. The reduction rate index and the final reduction degree determined by the laboratory are shown in Table 1.

### Comparative Example 1

In comparative example 1, a reducing gas, with a H₂ content of 66%, a CO content of 11%, a N2 content of 20%, and a CO₂ content of 3%, was used. The reducing temperature was 1050° C., and the flow rate of the reducing gas was 15 L/min. The material structure was, as shown in Table 1, 100% of alkaline pellets. The reduction rate index and the final reduction degree determined by the laboratory are shown in Table 1.

TABLE 1
Comparison of reduction index of pellet ore

| | | | Final |
|---|---|---|---|
| | | Reduction | reduction |
| | | rate index | degree |
| Name | Material structure | (wt %/min) | (%) |
| Comparative | 100% of alkaline pellets | 2.4 | 91.72 |
| example 1 | | | |
| Embodiment 1 | 83% of alkaline pellets + 17% | 2.6 | 93.23 |
| | of hot-pressed | | |
| | carbon-containing pellets | | |
| Embodiment 2 | 77.5% of alkaline pellets + | 2.9 | 94.95 |
| | 22.5% of hot-pressed | | |
| | carbon-containing pellets | | |
| Embodiment 3 | 72% of alkaline pellets + 28% | 3.1 | 96.48 |
| | of hot-pressed | | |
| | carbon-containing pellets | | |

From the above table, it can be seen that the reduction rate index and the final reduction degree of the embodiments were higher than those of the comparative example, which is due to the increase of the H₂ content, resulting in increase of the reduction capability, so that the reduction speed is accelerated. In the embodiments, the reduction rate and the final reduction degree were increased as increase of the proportion of the hot-pressed carbon-containing pellets, which is mainly due to the fact that C in the pellets participates in the reduction reaction, accelerating the reduction speed. Further, C directly reduces V and Ti which cannot be reduced by H₂ and CO to enter the molten iron, so that the final degree and the reduction rate are both enhanced.

For those skilled in the art, without departing from the scope of the technical solution of the present invention, many possible changes and modifications can be made to the technical solution of the present invention by using the technical contents disclosed above, or modified into equivalent embodiments with equivalent changes. Therefore, any simple modification, equivalent change and modification made to the above embodiments according to the technical essence of the present disclosure without departing from the technical solution of the present invention shall still belong to the protection scope of the technical solution of the present invention.

1. A reducing and non-blast furnace smelting method of alkaline vanadium-titanium pellets and hot-pressed carbon-containing vanadium-titanium pellets, comprising the following steps of:
\textcircled{1} upgrading a vanadium-titanium iron concentrate, and preparing alkaline pellets having an alkalinity of 0.6-0.7 from the upgraded vanadium-titanium iron concentrate and fine-grained limestone by using a belt roaster with a preheating temperature of 900-950° C., a preheating time of 13-17 minutes, a roasting temperature of 1250-1280° C., and a roasting time of 15-20 minutes;
\textcircled{2} preparing hot-pressed carbon-containing pellets with the upgraded vanadium-titanium iron concentrate and a pulverized coal, wherein a proportion of the pulverized coal is 17-28%, and a proportion of the upgraded vanadium-titanium iron concentrate is 72-83%, hot-pressing a uniform mixture of the upgraded vanadium-titanium iron concentrate and the pulverized coal to mold at 250-350° C., and then introducing nitrogen at 900-950° C. to remove volatile components in the pulverized coal;
\textcircled{3} by means of a pressure swing adsorption process, preparing H₂ with coke oven gas as a raw material, and preparing CO with converter gas as a raw material, and mixing the prepared H₂ and CO to obtain a reducing gas, featuring H₂/CO of greater than or equal to 8, and H₂+CO of greater than or equal to 90%;
\textcircled{4} preparing a fuel gas by mixing a remained gas after capturing CO₂ from blast furnace gas with the prepared CO;
\textcircled{5} feeding the reducing gas and the fuel gas into a shaft furnace through a double-layer conveying pipeline, wherein the fuel gas and air are fed through an inner layer, the reducing gas is fed through an outer layer, and the inner layer and the outer layer are isolated by a high thermal conductivity refractory, wherein a volume ratio of the fuel gas to the air is greater than or equal to 2.3:1, a temperature of the reducing gas is 1050-1080° C., and a pressure of the reducing gas is 0.7-0.8 MPa;
\textcircled{6} using a burden structure, containing the alkaline pellets and the hot-pressed carbon-containing pellets with a mass ratio of 1-5:1, as a shaft furnace burden, arranging the conveying pipeline of the reducing gas at a bottom of a reducing section and at half of the reducing section of the shaft furnace, removing a cooling section of the shaft furnace, increasing a length ratio of the reducing section to account for 60-80% of a height of the shaft furnace, and providing an unloading section with a metallized pellet storage bin having valves at both upper and lower ends, wherein the storage bin is provided with an inlet and an outlet, a tail gas after combustion of the fuel gas is introduced to the storage bin, and a content of O₂ in the tail gas is less than or equal to 3%; and
\textcircled{7} an electric furnace having a structure with four feed ports, two iron notches and two slag notches, achieving a continuous loading.

2. The reducing and non-blast furnace smelting method of alkaline vanadium-titanium pellets and hot-pressed carbon-containing vanadium-titanium pellets according to claim 1, wherein the upgraded vanadium-titanium iron concentrate in step \textcircled{1} features in a TFe content of 60-64%, a TiO₂ content of 8-11%, and a passing rate of 800-mesh sieve greater than 90%; and a proportion of the fine-grained limestone with a particle size of −0.1 mm is greater than or equal to 95%.

3. The method according to claim 1, wherein the alkaline pellets prepared in step \textcircled{1} features a TFe content of greater than or equal to 60%, a reduction swelling rate of less than or equal to 12%, and an average crushing strength of pellet of greater than or equal to 3000 N.

4. The method according to claim 1, wherein the pulverized coal for preparing the hot-pressed carbon-containing pellets in step \textcircled{2} is one-third coking coal or fat coal, and the pulverized coal features a volatile component content of 20-32%, a fixed carbon content of 60-70%, and an ash content of 6-12%.

5. The method according to claim 1, wherein the hot-pressed carbon-containing pellets prepared in step \textcircled{2} features a TFe content of 45-56%, a C content of 10-22%, and an average crushing strength of greater than or equal to 5500 N.

6. The method according to claim 1, wherein a metallization ratio of the metallized pellets prepared by the shaft furnace is greater than or equal to 92%.
